(19) United States
(12) Patent Application Publication
(10) Pub. No.: US 2024/0078425 A1
(43) Pub. Date: Mar. 7, 2024

(54) STATE CHANGE DETECTION FOR RESUMING CLASSIFICATION OF SEQUENTIAL SENSOR DATA ON EMBEDDED SYSTEMS

(71) Applicant: QUALCOMM Incorporated, San Diego, CA (US)

(72) Inventor: Haijun ZHAO, Beijing (CN)

(21) Appl. No.: 18/263,322

(22) PCT Filed: Mar. 23, 2021
(86) PCT No.: PCT/CN2021/082356

§ 371 Date: Jul. 27, 2023

(51) Int. Cl. G06N 3/08

(52) U.S. Cl. CPC G06N 3/08

(57) ABSTRACT

A method for energy-efficient classification receiving, via a first circuit, an input data stream from one or more sensors. The first circuit detects, while a second circuit is in a dormant state, if a state change has occurred between a first input of the input data stream and a second input of the input data stream. The second input is a next succeeding input of the input data stream. The first circuit triggers the second circuit to perform a classification of the input data stream in response to detecting the state change.

### BACKGROUND

### Field

Aspects of the present disclosure generally relate to artificial neural networks.

### Background

Artificial neural networks may comprise interconnected groups of artificial neurons (e.g., neuron models). The artificial neural network may be a computational device or be represented as a method to be performed by a computational device. Convolutional neural networks are a type of feed-forward artificial neural network. Convolutional neural networks may include collections of neurons that each have a receptive field and that collectively tile an input space. Convolutional neural networks (CNNs), such as deep convolutional neural networks (DCNs), have numerous applications. In particular, these neural network architectures are used in various technologies, such as image recognition, pattern recognition, speech recognition, autonomous driving, and other classification tasks.

Deep neural networks have greatly improved streaming data (e.g., image, video, inertial measurement unit (IMU), radar, and WiFi) classification performance. It is desirable to incorporate such networks with Internet of things (IoT) devices, smartphones, or other low-power devices that stream data. Unfortunately, the extensive resources consumed for classification due to the amount of computation involved makes it challenging to utilize deep neural networks on real-time, energy-sensitive applications on low power systems, such as a central processing unit (CPU), digital signal processor (DSP), reduced instruction set computer (RISC) processor, a microcontroller unit (MCU), or the like.

### SUMMARY

The present invention is set forth in the independent claims, respectively. Some preferred embodiments of the invention are described in the dependent claims.

In an aspect of the present disclosure, a method is provided. The method includes receiving, via a first circuit, an input data stream from one or more sensors. The method also includes detecting, via the first circuit, while a second circuit is in a dormant state, if a state change has occurred between a first input of the input data stream and a second input of the input data stream. The second input is a next succeeding input to the first input of the input data stream. Additionally, the method includes triggering, via the first circuit, the second circuit to perform a classification of the input data stream, in response to detecting the state change

In another aspect of the present disclosure, an apparatus is provided. The apparatus includes an input device to receive an input data stream from one or more sensors. The apparatus also includes a state change detection device to detect, while a second circuit is in a dormant state, if a state change has occurred between a first input of the input data stream and a second input of the input data stream. The second input is a next succeeding input to the first input of the input data stream. The apparatus further includes a control device to trigger the second circuit to perform a classification of the input data stream, in response to detecting the state change.

In another aspect of the present disclosure, an apparatus is provided. The apparatus includes means for receiving, via a first circuit, an input data stream from one or more sensors. The apparatus also includes means for detecting, via the first circuit, while a second circuit is in a dormant state, if a state change has occurred between a first input of the input data stream and a second input of the input data stream. The second input is a next succeeding input to the first input of the input data stream. Additionally, the apparatus includes triggering, via the first circuit, the second circuit to perform a classification of the input data stream, in response to detecting the state change.

In another aspect of the present disclosure, a non-transitory computer readable medium is provided. The computer readable medium has encoded thereon program code. The program code is executed by a processor and includes code to receive an input data stream from one or more sensors. The program code also includes code to detect, while a second circuit is in a dormant state, if a state change has occurred between a first input of the input data stream and a second input of the input data stream. The second input is a next succeeding input to the first input of the input data stream. Additionally, the program code includes code to trigger the second circuit to perform a classification of the input data stream, in response to detecting the state change.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of a neural network using a system-on-a-chip (SOC), including a general-purpose processor, in accordance with certain aspects of the present disclosure.

FIGS. 2A, 2B, and 2C are diagrams illustrating a neural network, in accordance with aspects of the present disclosure.

FIG. 2D is a diagram illustrating an exemplary deep convolutional network (DCN), in accordance with aspects of the present disclosure.

FIG. 3 is a block diagram illustrating an exemplary deep convolutional network (DCN), in accordance with aspects of the present disclosure.

FIG. 4 is a block diagram illustrating an exemplary software architecture that may modularize artificial intelligence (AI) functions, in accordance with aspects of the present disclosure.

FIG. 5 is a block diagram illustrating an example state change detection system, in accordance with aspects of the present disclosure.

FIGS. 6A and 6B are diagrams illustrating example functions of a state change detection block, in accordance with aspects of the present disclosure.

FIG. 7 illustrates a method for operating an artificial neural network, in accordance with aspects of the present disclosure.

### DETAILED DESCRIPTION

The detailed description set forth below, in connection with the appended drawings, is intended as a description of various configurations and is not intended to represent the only configurations in which the concepts described may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

The word “exemplary” is used to mean “serving as an example, instance, or illustration.” Any aspect described as “exemplary” is not necessarily to be construed as preferred or advantageous over other aspects.

Although particular aspects are described, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Deep neural networks (DNNs) have greatly improved streaming data (e.g., image, video, inertial measurement unit (IMU), radar, and Wi-Fi) classification performance. It is desirable to incorporate such networks with Internet of things (IoT) devices, smartphones, or other low-power devices for streaming data. Unfortunately, the extensive resources consumed for classification due to the amount of computation involved makes it challenging to utilize DNNs on real-time, energy-sensitive applications on low power systems, such as central processing units (CPUs), digital signal processors (DSPs), reduced instruction set computer (RISC) processors, microcontroller units (MCUs), and similar systems.

Many streaming data input sources, such as camera previews, video files, audio recordings, IMU data, radar data, and WiFi data, for instance provide sequential data with substantial temporal similarity. That is, many, and in some cases a majority of successive data points for such input sources are in the same distribution and a small number of data points change distribution such that a new classification may be indicated. As such, significant resources may be expended repeatedly computing classification to produce the same result for many successive data points.

To improve energy efficiency and maintain classification accuracy, aspects of the present disclosure are directed to a low computational state change detection component. In some aspects, the state change detection component may be integrated into a computing device, such as a smartphone, fitness tracker, IoT device, or a sensor, for example.

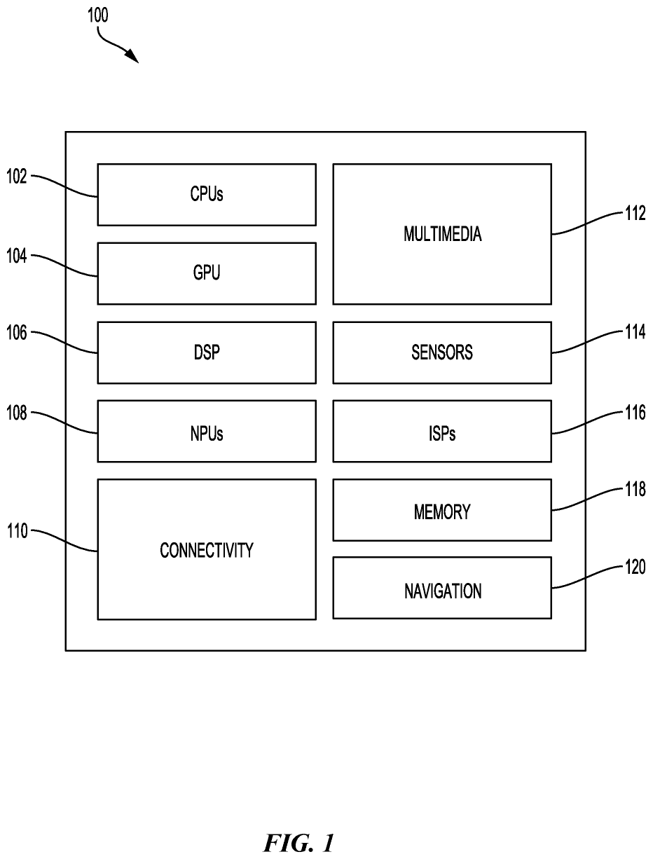

FIG. 1 illustrates an example implementation of a system-on-a-chip (SOC) 100, which may include a central processing unit (CPU) 102 or a multi-core CPU configured for energy-efficient feature extraction and classification (e.g., a neural end-to-end network). Variables (e.g., neural signals and synaptic weights), system parameters associated with a computational device (e.g., neural network with weights), delays, frequency bin information, and task information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU 108 is implemented in the CPU 102, DSP 106, and/or GPU 104. The SOC 100 may also include a sensor processor 114, image signal processors (ISPs) 116, and/or navigation module 120, which may include a global positioning system.

The SOC 100 may be based on an ARM instruction set. In an aspect of the present disclosure, the instructions loaded into the general-purpose processor 102 may include code to receive via a first circuit, an input data stream from one or more sensors. The general-purpose processor 102 may also include code to detect, via the first circuit, while a second circuit is in a dormant state, if a state change has occurred between a first input of the input data stream and a second input of the input data stream. The second input is the next succeeding input to the first input of the data stream. The general-purpose processor 102 may further include code to trigger, via the first circuit, the second circuit to perform a classification of the input data stream, in response to detecting the state change.

Deep learning architectures may perform an object recognition task by learning to represent inputs at successively higher levels of abstraction in each layer, thereby building up a useful feature representation of the input data. In this way, deep learning addresses a major bottleneck of traditional machine learning. Prior to the advent of deep learning, a machine learning approach to an object recognition problem may have relied heavily on human engineered features, perhaps in combination with a shallow classifier. A shallow classifier may be a two-class linear classifier, for example, in which a weighted sum of the feature vector components may be compared with a threshold to predict to which class the input belongs. Human engineered features may be templates or kernels tailored to a specific problem domain by engineers with domain expertise. Deep learning architectures, in contrast, may learn to represent features that are similar to what a human engineer might design, but through training. Furthermore, a deep network may learn to represent and recognize new types of features that a human might not have considered.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

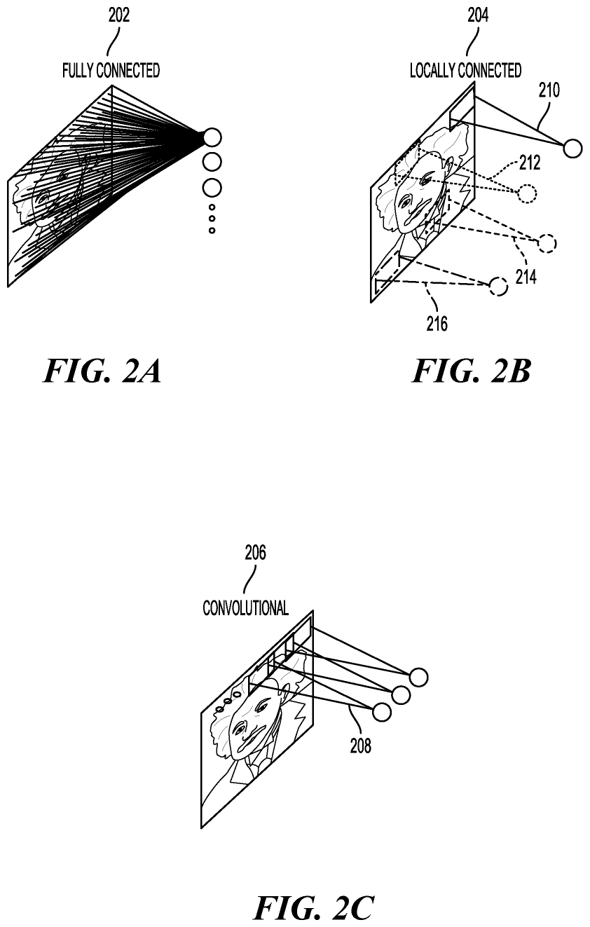

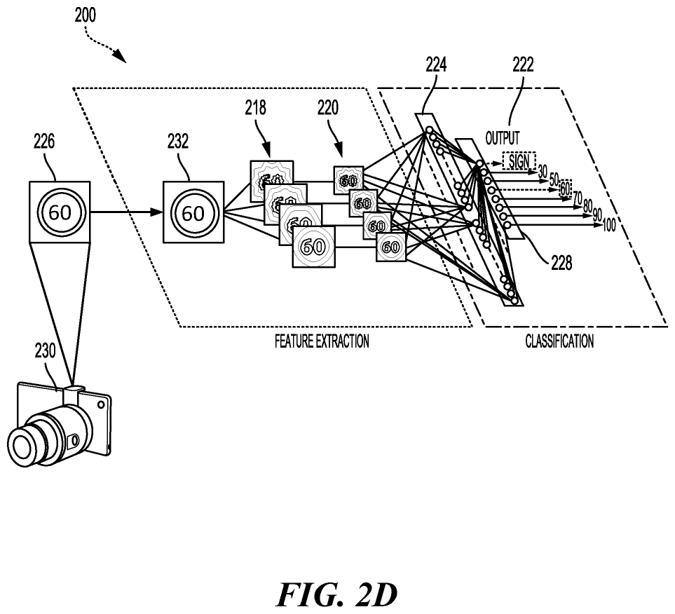

The connections between layers of a neural network may be fully connected or locally connected. FIG. 2A illustrates an example of a fully connected neural network 202. In a fully connected neural network 202, a neuron in a first layer may communicate its output to every neuron in a second layer, so that each neuron in the second layer will receive input from every neuron in the first layer. FIG. 2B illustrates an example of a locally connected neural network 204. In a locally connected neural network 204, a neuron in a first layer may be connected to a limited number of neurons in the second layer. More generally, a locally connected layer of the locally connected neural network 204 may be configured so that each neuron in a layer will have the same or a similar connectivity pattern, but with connections strengths that may have different values (e.g., 210, 212, 214, and 216). The locally connected connectivity pattern may give rise to spatially distinct receptive fields in a higher layer, because the higher layer neurons in a given region may receive inputs that are tuned through training to the properties of a restricted portion of the total input to the network.

One example of a locally connected neural network is a convolutional neural network. FIG. 2C illustrates an example of a convolutional neural network 206. The convolutional neural network 206 may be configured such that the connection strengths associated with the inputs for each neuron in the second layer are shared (e.g., 208). Convolutional neural networks may be well suited to problems in which the spatial location of inputs is meaningful.

One type of convolutional neural network is a deep convolutional network (DCN). FIG. 2D illustrates a detailed example of a DCN 200 designed to recognize visual features from an image 226 input from an image capturing device 230, such as a car-mounted camera. The DCN 200 of the current example may be trained to identify traffic signs and a number provided on the traffic sign. Of course, the DCN 200 may be trained for other tasks, such as identifying lane markings or identifying traffic lights.

The DCN 200 may be trained with supervised learning. During training, the DCN 200 may be presented with an image, such as the image 226 of a speed limit sign, and a forward pass may then be computed to produce an output 222. The DCN 200 may include a feature extraction section and a classification section. Upon receiving the image 226, a convolutional layer 232 may apply convolutional kernels (not shown) to the image 226 to generate a first set of feature maps 218. As an example, the convolutional kernel for the convolutional layer 232 may be a 5×5 kernel that generates 28×28 feature maps. In the present example, because four different feature maps are generated in the first set of feature maps 218, four different convolutional kernels were applied to the image 226 at the convolutional layer 232. The convolutional kernels may also be referred to as filters or convolutional filters.

The first set of feature maps 218 may be subsampled by a max pooling layer (not shown) to generate a second set of feature maps 220. The max pooling layer reduces the size of the first set of feature maps 218. That is, a size of the second set of feature maps 220, such as 14×14, is less than the size of the first set of feature maps 218, such as 28×28. The reduced size provides similar information to a subsequent layer while reducing memory consumption. The second set of feature maps 220 may be further convolved via one or more subsequent convolutional layers (not shown) to generate one or more subsequent sets of feature maps (not shown).

In the example of FIG. 2D, the second set of feature maps 220 is convolved to generate a first feature vector 224. Furthermore, the first feature vector 224 is further convolved to generate a second feature vector 228. Each feature of the second feature vector 228 may include a number that corresponds to a possible feature of the image 226, such as “sign,” “60,” and “100.” A softmax function (not shown) may convert the numbers in the second feature vector 228 to a probability. As such, an output 222 of the DCN 200 is a probability of the image 226 including one or more features.

In the present example, the probabilities in the output 222 for “sign” and “60” are higher than the probabilities of the others of the output 222, such as “30,” “40,” “50,” “70,” “80,” “90,” and “100”. Before training, the output 222 produced by the DCN 200 is likely to be incorrect. Thus, an error may be calculated between the output 222 and a target output. The target output is the ground truth of the image 226 (e.g., “sign” and “60”). The weights of the DCN 200 may then be adjusted so the output 222 of the DCN 200 is more closely aligned with the target output.

To adjust the weights, a learning algorithm may compute a gradient vector for the weights. The gradient may indicate an amount that an error would increase or decrease if the weights were adjusted. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted to reduce the error. This manner of adjusting the weights may be referred to as “back propagation” as it involves a “backward pass” through the neural network.

In practice, the error gradient of weights may be calculated over a small number of examples, so that the calculated gradient approximates the true error gradient. This approximation method may be referred to as stochastic gradient descent. Stochastic gradient descent may be repeated until the achievable error rate of the entire system has stopped decreasing or until the error rate has reached a target level. After learning, the DCN may be presented with new images and a forward pass through the network may yield an output 222 that may be considered an inference or a prediction of the DCN.

Deep belief networks (DBNs) are probabilistic models comprising multiple layers of hidden nodes. DBNs may be used to extract a hierarchical representation of training data sets. A DBN may be obtained by stacking up layers of Restricted Boltzmann Machines (RBMs). An RBM is a type of artificial neural network that can learn a probability distribution over a set of inputs. Because RBMs can learn a probability distribution in the absence of information about the class to which each input should be categorized, RBMs are often used in unsupervised learning. Using a hybrid unsupervised and supervised paradigm, the bottom RBMs of a DBN may be trained in an unsupervised manner and may serve as feature extractors, and the top RBM may be trained in a supervised manner (on a joint distribution of inputs from the previous layer and target classes) and may serve as a classifier.

Deep convolutional networks (DCNs) are networks of convolutional networks, configured with additional pooling and normalization layers. DCNs have achieved state-of-the-art performance on many tasks. DCNs can be trained using supervised learning in which both the input and output targets are known for many exemplars and are used to modify the weights of the network by use of gradient descent methods.

DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections.

The processing of each layer of a convolutional network may be considered a spatially invariant template or basis projection. If the input is first decomposed into multiple channels, such as the red, green, and blue channels of a color image, then the convolutional network trained on that input may be considered three-dimensional, with two spatial dimensions along the axes of the image and a third dimension capturing color information. The outputs of the convolutional connections may be considered to form a feature map in the subsequent layer, with each element of the feature map (e.g., 220) receiving input from a range of neurons in the previous layer (e.g., feature maps 218) and from each of the multiple channels. The values in the feature map may be further processed with a non-linearity, such as a rectification, max(0, x). Values from adjacent neurons may be further pooled, which corresponds to down sampling, and may provide additional local invariance and dimensionality reduction. Normalization, which corresponds to whitening, may also be applied through lateral inhibition between neurons in the feature map.

The performance of deep learning architectures may increase as more labeled data points become available or as computational power increases. Modern deep neural networks are routinely trained with computing resources that are thousands of times greater than what was available to a typical researcher just fifteen years ago. New architectures and training paradigms may further boost the performance of deep learning. Rectified linear units may reduce a training issue known as vanishing gradients. New training techniques may reduce over-fitting and thus enable larger models to achieve better generalization. Encapsulation techniques may abstract data in a given receptive field and further boost overall performance.

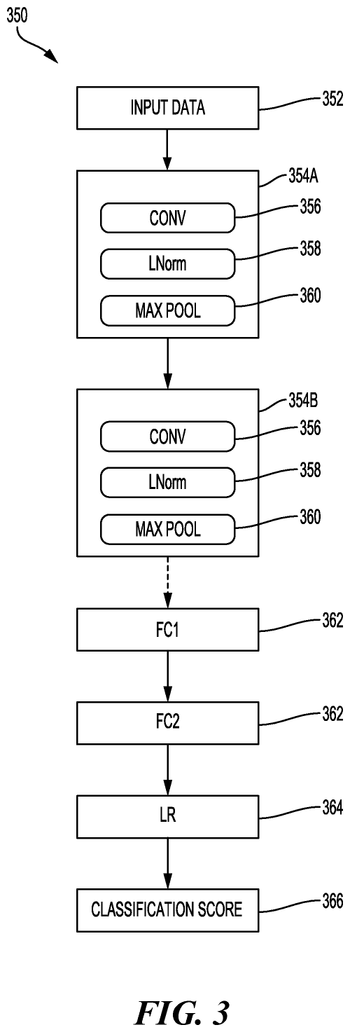

FIG. 3 is a block diagram illustrating a deep convolutional network 350. The deep convolutional network 350 may include multiple different types of layers based on connectivity and weight sharing. As shown in FIG. 3, the deep convolutional network 350 includes the convolution blocks 354A, 354B. Each of the convolution blocks 354A, 354B may be configured with a convolution layer (CONV) 356, a normalization layer (LNorm) 358, and a max pooling layer (MAX POOL) 360.

The convolution layers 356 may include one or more convolutional filters, which may be applied to the input data to generate a feature map. Although only two of the convolution blocks 354A, 354B are shown, the present disclosure is not so limiting, and instead, any number of the convolution blocks 354A, 354B may be included in the deep convolutional network 350 according to design preference. The normalization layer 358 may normalize the output of the convolution filters. For example, the normalization layer 358 may provide whitening or lateral inhibition. The max pooling layer 360 may provide down sampling aggregation over space for local invariance and dimensionality reduction.

The parallel filter banks, for example, of a deep convolutional network may be loaded on a CPU 102 or GPU 104 of an SOC 100 to achieve high performance and low power consumption. In alternative embodiments, the parallel filter banks may be loaded on the DSP 106 or an ISP 116 of an SOC 100. In addition, the deep convolutional network 350 may access other processing blocks that may be present on the SOC 100, such as sensor processor 114 and navigation module 120, dedicated, respectively, to sensors and navigation.

The deep convolutional network 350 may also include one or more fully connected layers 362 (FC1 and FC2). The deep convolutional network 350 may further include a logistic regression (LR) layer 364. Between each layer 356, 358, 360, 362, 364 of the deep convolutional network 350 are weights (not shown) that are to be updated. The output of each of the layers (e.g., 356, 358, 360, 362, 364) may serve as an input of a succeeding one of the layers (e.g., 356, 358, 360, 362, 364) in the deep convolutional network 350 to learn hierarchical feature representations from input data 352 (e.g., images, audio, video, sensor data and/or other input data) supplied at the first of the convolution blocks 354A. The output of the deep convolutional network 350 is a classification score 366 for the input data 352. The classification score 366 may be a set of probabilities, where each probability is the probability of the input data including a feature from a set of features.

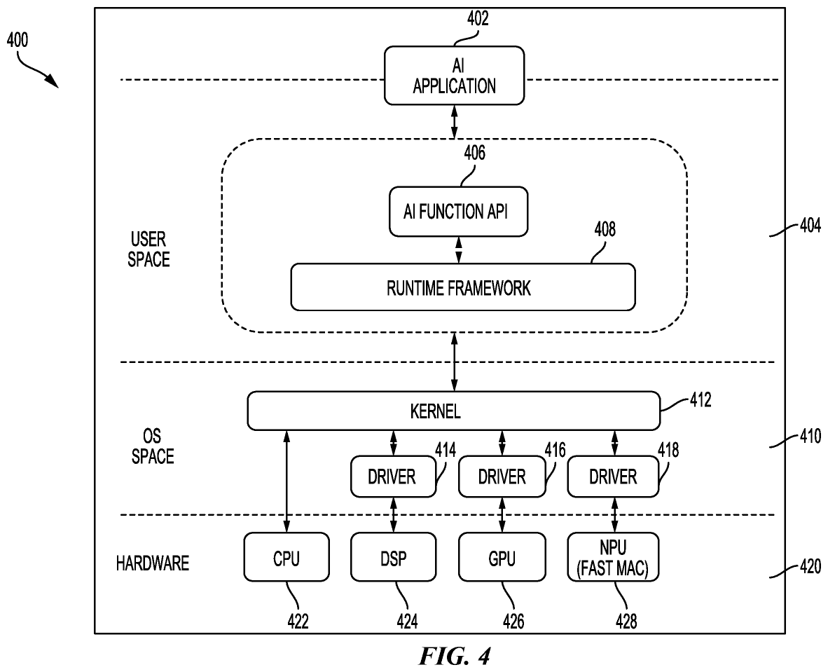

FIG. 4 is a block diagram illustrating an exemplary software architecture 400 that may modularize artificial intelligence (AI) functions. Using the architecture, applications may be designed that may cause various processing blocks of an SOC 420 (for example a CPU 422, a DSP 424, a GPU 426 and/or an NPU 428) to support adaptive rounding as disclosed for post-training quantization for an AI application 402, according to aspects of the present disclosure.

The AI application 402 may be configured to call functions defined in a user space 404 that may, for example, provide for the detection and recognition of a scene indicative of the location in which the device currently operates. The AI application 402 may, for example, configure a microphone and a camera differently depending on whether the recognized scene is an office, a lecture hall, a restaurant, or an outdoor setting such as a lake. The AI application 402 may make a request to compiled program code associated with a library defined in an AI function application programming interface (API) 406. This request may ultimately rely on the output of a deep neural network configured to provide an inference response based on video and positioning data, for example.

A run-time engine 408, which may be compiled code of a runtime framework, may be further accessible to the AI application 402. The AI application 402 may cause the run-time engine, for example, to request an inference at a particular time interval or triggered by an event detected by the user interface of the application. When caused to provide an inference response, the run-time engine may in turn send a signal to an operating system in an operating system (OS) space 410, such as a Kernel 412, running on the SOC 420. In some examples, the Kernel 412 may be a LINUX Kernel. The operating system, in turn, may cause a continuous relaxation of quantization to be performed on the CPU 422, the DSP 424, the GPU 426, the NPU 428, or some combination thereof. The CPU 422 may be accessed directly by the operating system, and other processing blocks may be accessed through a driver, such as a driver 414, 416, or 418 for, respectively, the DSP 424, the GPU 426, or the NPU 428. In the exemplary example, the deep neural network may be configured to run on a combination of processing blocks, such as the CPU 422, the DSP 424, and the GPU 426, or may be run on the NPU 428.

The application 402 (e.g., an AI application) may be configured to call functions defined in a user space 404 that may, for example, provide for the detection and recognition of a scene indicative of the location in which the device currently operates. The application 402 may, for example, configure a microphone and a camera differently depending on whether the recognized scene is an office, a lecture hall, a restaurant, or an outdoor setting such as a lake. The application 402 may make a request to compiled program code associated with a library defined in a SceneDetect application programming interface (API) 406 to provide an estimate of the current scene. This request may ultimately rely on the output of a differential neural network configured to provide scene estimates based on video and positioning data, for example.

A run-time engine 408, which may be compiled code of a Runtime Framework, may be further accessible to the application 402. The application 402 may cause the run-time engine, for example, to request a scene estimate at a particular time interval or triggered by an event detected by the user interface of the application. When caused to estimate the scene, the run-time engine may in turn send a signal to an operating system 410, such as a Linux Kernel 412, running on the SOC 420. The operating system 410, in turn, may cause a computation to be performed on the CPU 422, the DSP 424, the GPU 426, the NPU 428, or some combination thereof. The CPU 422 may be accessed directly by the operating system, and other processing blocks may be accessed through a driver, such as a driver 414-418 for a DSP 424, for a GPU 426, or for an NPU 428. In the exemplary example, the differential neural network may be configured to run on a combination of processing blocks, such as a CPU 422 and a GPU 426, or may be run on an NPU 428.

Aspects of the present disclosure are directed to a state change detection device for waking up sequential sensor data classification.

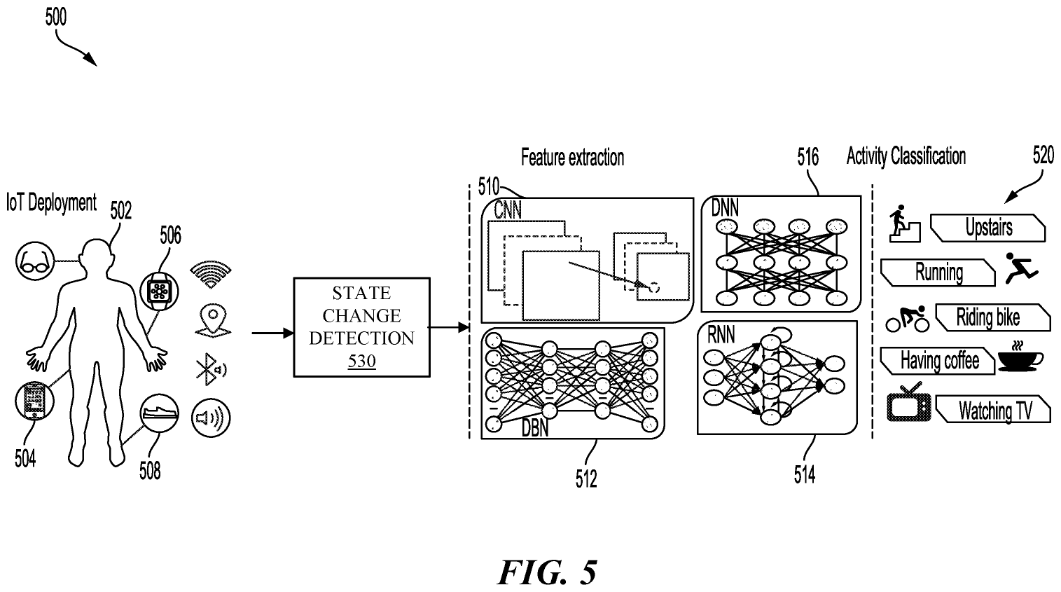

FIG. 5 is a block diagram illustrating an example energy-efficient classification system 500, in accordance with aspects of the present disclosure. Referring to FIG. 5, the example classification system 500 may receive streaming data as an input. The streaming data may include data continuously generated by a source. The data may be in the form of audio, video or a combination thereof, for example. As shown in the example of FIG. 5, the input data may be supplied, for example, via an Internet of Things (IoT) source such as smart glasses 502, a smart phone 504, a smart watch 506 or a sensor in a shoe 508. Of course, these sources are merely exemplary and not limiting. The streaming data may be received via a communication medium such as Wi-Fi, GPS, Bluetooth, or via speaker, for instance.

The system 500 may include a convolutional neural network (CNN) 510. The CNN 510 may extract features from the input data. The extracted features may be processed via a classifier. The classifier may, for example, be a deep belief network (DBN) 512, a recurrent neural network (RNN) 514, or a deep neural network (DNN) 516. The classifier may be configured for inference detection and may provide a classification of the input. In one example, the classifier (e.g., 512, 514, or 516) may classify an activity in image data provided via the smartphone 504. An activity classification 520 may indicate that a person is climbing stairs, positioned upstairs, running, riding a bicycle, having coffee, or watching television, for example.

Rather than operating the classifier (e.g., 512, 514, or 516) to compute a classification for every data point in the data stream, the system 500 is configured with a state change detection block 530 to detect a change in successive data points supplied by one or more of the input devices (e.g., smart phone 504 or smart watch 506). The state change detection block 530 may be configured as separate circuitry or may be incorporated with a input device (e.g., sensor in shoe 508) for instance. In some aspects, a difference in the successive data points may be computed.

When the state change detection block 530 detects a change in the data stream from input device (e.g., smart phone 504 or smart watch 506), the state change detection block may provide a signal or other indication to trigger or otherwise cause the CNN 510 to wake up and resume processing of the input data to generate a classification. Conversely, when the state change detection block 530 does not detect a change in the data stream from the input device(s), the state change detection block 530 may provide an indication to cause the CNN 510 to enter or remain in a low power or sleep state.

The state change detection block 530 may detect a state change based on a comparison of the difference with a predefined threshold value, for example. In some aspects, the state change detection block 530 may detect a state change by computing a similarity score metric between successive data points and comparing the similarity score metric to a threshold value. The similarity score metric may be determined based on a peak signal-to-noise ratio (PSNR), structural similarity (SSIM), cosine similarity, or the like, for example.

In some aspects, the state change detection block 530 may include a feature extractor to detect features of the input data from a sensor that may in turn be used to determine whether the state of the input has changed. In some aspects, the state change detection block 530 may also include a classifier to generate an inference on whether a state change has occurred. For example, in one implementation, the state change detection block 530 may include a binary classifier which may receive the input data stream (e.g., data representing an audio or video stream) and may determine a prediction of whether the state of the data stream has changed.

In some aspects, the state change detection block 530 may detect a state change based on a segment length of data in the data stream. For example, each input from a camera may be a single data point, while an input from an inertial measurement unit (IMU) may be a segment of data. As such, the state change detection block 230 may detect a state change when data is received from a predefined type of input device and the defined amount of data has been received in succession.

Additionally, offline statistical analysis may performed to determine parameter configurations for determining whether a state change has occurred for different applications. For instance, in some aspects, the state change parameter configurations (e.g., similarity score metric may be learned based on the application). In another example, the state change parameters may be determined based on a buffer implementation or based on an architecture of the CNN 510 (e.g., a CNN, a CNN+long-short term memory (CNN+LSTM)), an attention model, or other neural network architecture) or training dataset.

If the difference is less than the threshold (e.g., state change threshold), then a state change may be detected. Likewise, where a similarity metric is used, if the similarity metric is greater than a threshold value (indicating that successive data points have a higher degree of similarity), then a state change may not be detected. If a state change is not detected, then the CNN 510 or classifier (e.g., 512, 514, or 516) may be maintained in a sleep or low-power state.

On the other hand, if the difference is greater than the threshold, then a state change may be detected. Likewise, where a similarity metric is used, if the similarity metric is less than a threshold value (indicating that successive data points have a lower degree of similarity) then a state change may be detected. If a state change is detected, the CNN 510 or the classifier (e.g., 512, 514, or 516) may wake up from a sleep state and respectively extract features of the input or compute classification for the input data (e.g., the later received data of the successive data points).

In some aspects, the system 500 may further implement periodic wake ups for the classifier (e.g., 512, 514, or 516). That is, the system 500 may be further configured to wake up the classifier one time for every Nth data input with no state change.

In one operative example, system 500 may be configured as a low-power birdwatching device. The birdwatching device may receive data from a camera sensor (e.g., a camera of smartphone 506). The bird watching device may be configured with a feature extractor (e.g., CNN 510) and a classifier (e.g., 512, 514, or 516) which may be configured to classify a type of bird observed within a frame of the streaming data from the camera sensor. In this example, the bird watching device may be configured with the state change detection block 530 which may detect whether the sequential frames supplied by the camera sensor includes an object in motion. If there is a motion (e.g., an object moving in the air), then state change detection block 530 may generate a signal or other indication to wake up the feature extractor and the classifier to classify the object in motion. In another example, when a bird-like sound is observed, the state change detection block 530 may wake up a feature extractor (e.g., CNN 510) and classifier (e.g., 512, 514, or 516) to determine if a bird is present in a frame of a corresponding video. Otherwise, the state change detection block 530 may control the feature extractor and classifier (e.g., CNN 510) and classifier (e.g., 512, 514, or 516) to remain in the sleep state.

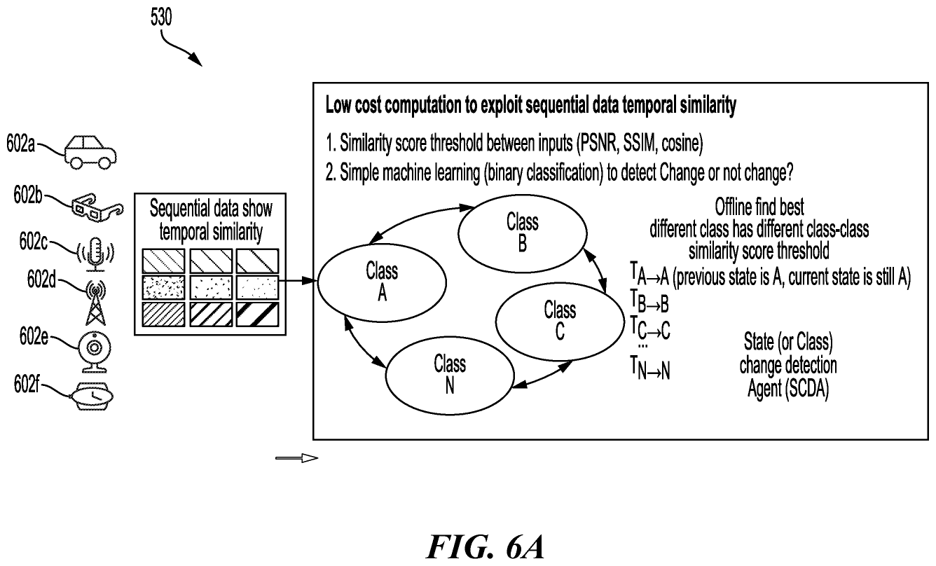

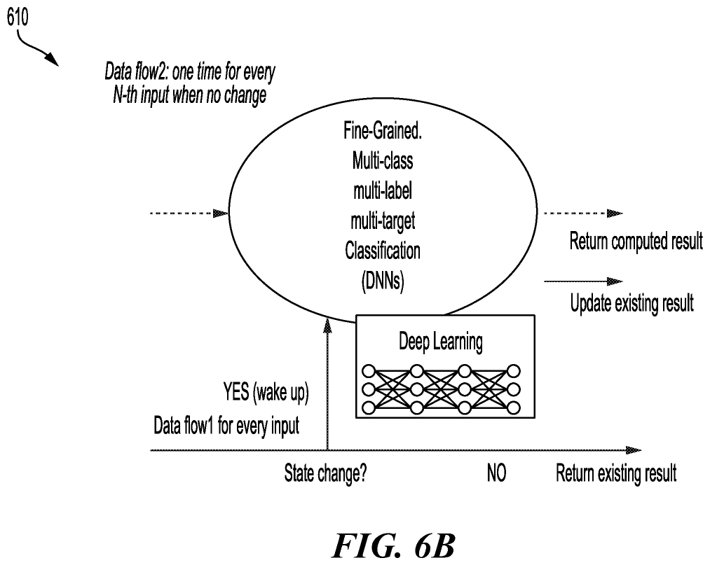

FIGS. 6A and 6B are diagrams illustrating functions of an example implementation of the state change detection block 530, in accordance with aspects of the present disclosure. Referring to FIG. 6A, the state change detection block 530 may receive streaming sequential input data from one or more sources such as IoT devices or other sensors, which may be incorporated into an automobile 602a, glasses 602b, a microphone 602c, a cellular device 602d, a camera 602e, or a smart watch 602f, for example. In some aspects, the state change detection block 530 may be incorporated with a sensor (e.g., camera 602e).

The state change detection block 530 may determine whether there has been a change in the input data stream (e.g., a change in the speaker of an audio stream, a change in a type of bird observed in a video, or an change in the input device). The state change detection block 530 may compute a similarity score metric for successive data points. The similarity score metric may be determined based on a peak signal-to-noise ratio (PSNR), structural similarity (SSIM), cosine similarity, or the like, for example. The similarity score metric may be compared to a predefined threshold value. If the similarity score metric is greater than the predefined threshold, then the state change detection block 530 may determine that the state (e.g., class) has not changed. That is, the state change detection block 530 may determine that the state of a first input and the state of a next succeeding input is the same. As such, the state change detection block 530 may determine that a state change has not been detected.

Conversely, if the similarity score metric is less than the predefined threshold, then the state change detection block 530 may determine that the state has changed. That is, the state change detection block 530 may determine that the state of the first input and the state of the next succeeding input are different. As such, the state change detection block 530 may determine that a state change has been detected. The state change detection block 530 may supply an indication of the state detection (or non-detection) to feature extractor (e.g., CNN 510 of FIG. 5) or a classifier (e.g., e.g., 512, 514, or 516 of FIG. 5) The indication may serve as a control signal to indicate whether the classifier is to remain in a sleep state (e.g., when a state change is not detected) or to wake up and resume computation of classification results based on the received input (e.g., when a state change is detected).

In some aspects, the state change detection block 530 may include a binary classifier (not shown). The binary classifier may be trained to detect or predict a state or class change based on a similarity score metric. In some aspects, the binary classifier may be trained offline to determine an optimal state change threshold value.

In some aspects, the state change detection block 530 may also provide An intermittent (e.g., periodic) wake up indication. For example, if a state change has not been detected during a predefined time period, then the state change detection block 530 may supply a signal to wake up the classifier to classify the received input or a period of time to provide feedback to the state-change detector and/or fine-tune the feature extractor and/or classifier.

Referring to FIG. 6B, the state change, detected by the state change detection block 530 (shown in FIG. 6A) is supplied to a classifier 610. If the state change detection block 530 indicates that a state change has occurred, the classifier 610 (e.g., DNN 516 of FIG. 5) may wake up to compute a classification for the successive data points. In some aspects, if a predefined period N has elapsed without a state change, the classifier 610 may wake up and compute a classification for the most recently received input data point.

On the other hand, if the state change detection block 530 indicates that a state change has not been detected, the classifier 610 (e.g., DNN 516) may remain in a sleep state. Rather than computing a classification result for the most recently received data point (e.g., the succeeding data point), the classification result for such data may be set to be equal to the classification result for the preceding data point. As such, redundant computations of classification results (e.g., computations likely to produce the same classification result) may be reduced.

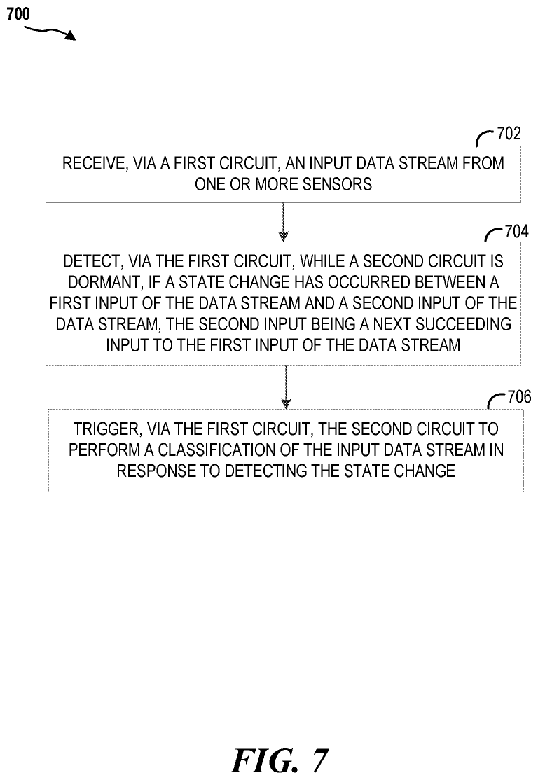

FIG. 7 illustrates a method 700 for energy-efficient classification, in accordance with aspects of the present disclosure. As shown in FIG. 7, at block 702, an input data stream from one or more sensors is received via a first circuit. As described with reference to FIG. 6A, the state change detection block 530 may receive streaming sequential input data from one or more sources, such as IoT devices or other sensors that may be incorporated into an automobile 602a, glasses 602b, a microphone 602c, a cellular device 602d, a camera 602e, or a watch 602f, for example.

At block 704, a state change between a first input of the data stream and a second input of the data stream is detected via the first circuit while a second circuit is dormant. The second input is a next succeeding input to the first input. As described with reference to FIG. 6A, the state change detection block 530 may compute a similarity score metric for successive data points. The similarity score may be supplied to a binary classifier trained to detect whether a state change is detected or not based on the similarity score. In some aspects, the similarity metric may be peak signal-to-noise ratio, a structural similarity, or a cosine similarity. The similarity score may be compared to a predefined threshold to determine whether a state change has occurred.

At block 706, the second circuit is triggered, via the first circuit, to perform a classification of the input data stream in response to the state change. As described with reference to FIG. 6B, if the similarity score metric is less than the predefined threshold, then the state change detection block 530 may determine that the state has changed. That is, the state change detection block 530 may determine that the state of the first input and the state of the next succeeding input are different. As such, the state change detection block 530 may determine that a state change has not been detected. The state change detection block 530 may supply an indication of the state detection (or non-detection) to feature extractor (e.g., CNN 510 of FIG. 5) or a classifier (e.g., e.g., 512, 514, or 516 of FIG. 5) The indication may serve as a control signal to indicate whether the classifier is to remain in a sleep state (e.g., when a state change is not detected) or to wake up and resume computation of classification results based on the received input (e.g., when a state change is detected).

Implementation examples are described in the following numbered clauses:

1. A method, comprising:
receiving, via a first circuit, an input data stream from one or more sensors;
detecting, via the first circuit, while a second circuit is in a dormant state, if a state change has occurred between a first input of the input data stream and a second input of the input data stream, the second input being a next succeeding input to the first input of the input data stream; and
triggering, via the first circuit, the second circuit to perform a classification of the input data stream, in response to detecting the state change.

2. The method of claim 1, in which the classification is different from a state detected via the first circuit.

3. The method of clause 1 or 2, further comprising triggering, via the first circuit, the second circuit to extract a set of features of at least the second input of the input data stream.

4. The method of any of clauses 1-3, further comprising computing, via the first circuit, a similarity score between the first input and the second input, the state change being detected based on the similarity score.

5. The method of any of clauses 1-4, further comprising comparing, via the first circuit, the similarity score to a predefined threshold; and detecting the state change has occurred in response to the similarity score being below the predefined threshold.

6. The method of any of clauses 1-5, in which the similarity score is based on a metric selected from a group consisting of a peak signal to noise ratio, a structural similarity, and a cosine similarity.

7. The method of any of clauses 1-6, further comprising triggering via the first circuit, the second circuit to perform the classification of the input data stream, in response to a predefined time period elapsing without the state change being detected.

8. The method of any of clauses 1-7, further comprising, triggering, via the first circuit, the second circuit to return to the dormant state and setting a subsequent classification for at least one subsequent input of the input data stream to be equal to a previously computed classification for a preceding input of the input data stream.

9. An apparatus, comprising:
an input device to receive an input data stream from one or more sensors;
a state change detection device to detect, while a second circuit is in a dormant state, if a state change has occurred between a first input of the input data stream and a second input of the input data stream, the second input being a next succeeding input to the first input of the input data stream; and
a control device to trigger the second circuit to perform a classification of the input data stream, in response to detecting the state change.

10. The apparatus of clause 9, in which the second circuit includes a feature extractor, and the control device, triggers the feature extractor to extract a set of features of at least the second input of the input data stream.

11. The apparatus of any of clauses 9-10, in which the state change detection device computes a similarity score between the first input and the second input, the state change being detected based on the similarity score.

12. The apparatus of any of clauses 9-11, in which the state change detection device compares the similarity score to a predefined threshold and detects the state change has occurred in response to the similarity score being below the predefined threshold.

13. The apparatus of any of clauses 9-12, in which the control device triggers the second circuit to return to the dormant state, in response to a second similarity score computed for the second input and a third input exceeding the predefined threshold.

14. The apparatus of any of clauses 9-13, in which the similarity score is computed based on a metric selected from a group consisting of a peak signal to noise ratio, a structural similarity, and a cosine similarity.

15. The apparatus of any of clauses 9-14, in which the control device triggers the second circuit to perform the classification of the input data stream, in response to a predefined time period elapsing without the state change being detected.

16. The apparatus of any of clauses 9-15, in which the state change detection device comprises a binary classifier.

17. An apparatus, comprising:
means for receiving, via a first circuit, an input data stream from one or more sensors;
means for detecting, via the first circuit, while a second circuit is in a dormant state, if a state change has occurred between a first input of the input data stream and a second input of the input data stream, the second input being a next succeeding input to the first input of the input data stream; and
means for triggering, via the first circuit, the second circuit to perform a classification of the input data stream, in response to detecting the state change.

18. The apparatus of clause 17, further comprising means for triggering, via the first circuit, the second circuit to extract a set of features of at least the second input of the input data stream.

19. The apparatus of any of clauses 17-18, further comprising means for computing, via the first circuit, a similarity score between the first input and the second input, the state change being detected based on the similarity score.

20. The apparatus of any of clauses 17-19, further comprising means for comparing, via the first circuit, the similarity score to a predefined threshold; and means detecting the state change has occurred in response to the similarity score being below the predefined threshold.

21. The apparatus of any of clauses 17-20, in which the similarity score is based on a metric selected from a group consisting of a peak signal to noise ratio, a structural similarity, and a cosine similarity.

22. The apparatus of any of clauses 17-21, further comprising means for triggering via the first circuit, the second circuit to perform the classification of the input data stream, in response to a predefined time period elapsing without a state change being detected.

23. The apparatus of any of clauses 17-22, further comprising, means for triggering, via the first circuit, the second circuit to return to the dormant state.

24. A non-transitory computer readable medium having encoded thereon program code, the program code being executed by a processor and comprising:
program code to receive, via a first circuit, an input data stream from one or more sensors;
program code to detect, via the first circuit, while a second circuit is in a dormant state, if a state change has occurred between a first input of the input data stream and a second input of the input data stream, the second input being a next succeeding input to the first input of the input data stream; and
program code to trigger, via the first circuit, the second circuit to perform a classification of the input data stream, in response to detecting the state change.

25. The non-transitory computer readable medium of clause 24, further comprising program code to trigger, via the first circuit, the second circuit to extract a set of features of at least the second input of the input data stream.

26. The non-transitory computer readable medium of any of clauses 24-25, further comprising program code to compute, via the first circuit, a similarity score between the first input and the second input, the state change being detected based on the similarity score.

27. The non-transitory computer readable medium of any of clauses 24-26, further comprising program code to compare, via the first circuit, the similarity score to a predefined threshold; and detecting the state change has occurred in response to the similarity score being below the predefined threshold.

28. The non-transitory computer readable medium of any of clauses 24-27, in which the similarity score is based on a metric selected from a group consisting of a peak signal to noise ratio, a structural similarity, and a cosine similarity.

29. The non-transitory computer readable medium of any of clauses 24-28, further comprising program code to trigger, via the first circuit, the second circuit to perform the classification of the input data stream, in response to a predefined time period elapsing without a state change being detected.

30. The non-transitory computer readable medium of any of clauses 24-29, further comprising program code to trigger, via the first circuit, the second circuit to return to the dormant state.

In one aspect, the receiving means, detecting means, triggering means, computing means comparing means and/or returning means may be the CPU 102, program memory associated with the CPU 102, the dedicated memory block 118, fully connected layers 362, NPU 428 and or the routing connection processing unit 216 configured to perform the functions recited. In another configuration, the aforementioned means may be any module or any apparatus configured to perform the functions recited by the aforementioned means.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

As used herein, the term “determining” encompasses a wide variety of actions. For example, “determining” may include calculating, computing, processing, deriving, investigating, looking up (e.g., looking up in a table, a database or another data structure), ascertaining and the like. Additionally, “determining” may include receiving (e.g., receiving information), accessing (e.g., accessing data in a memory) and the like. Furthermore, “determining” may include resolving, selecting, choosing, establishing, and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general-purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable Read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described. For certain aspects, the computer program product may include packaging material.

Further, it should be appreciated that modules and/or other appropriate means for performing the methods and techniques described can be downloaded and/or otherwise obtained by a user terminal and/or base station as applicable. For example, such a device can be coupled to a server to facilitate the transfer of means for performing the methods described. Alternatively, various methods described can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. A method for operating an artificial neural network, comprising:
receiving, via a first circuit, an input data stream from one or more sensors;
detecting, via the first circuit, while a second circuit is in a dormant state, if a state change has occurred between a first input of the input data stream and a second input of the input data stream, the second input being a next succeeding input to the first input of the input data stream; and
triggering, via the first circuit, the second circuit to perform a classification of the input data stream, in response to detecting the state change.

2. The method of claim 1, in which the classification is different from a state detected via the first circuit.

3. The method of claim 1, further comprising triggering, via the first circuit, the second circuit to extract a set of features of at least the second input of the input data stream.

4. The method of claim 1, further comprising computing, via the first circuit, a similarity score between the first input and the second input, the state change being detected based on the similarity score.

5. The method of claim 4, further comprising comparing, via the first circuit, the similarity score to a predefined threshold; and detecting the state change has occurred in response to the similarity score being below the predefined threshold.

6. The method of claim 4, in which the similarity score is based on a metric selected from a group consisting of a peak signal to noise ratio, a structural similarity, and a cosine similarity.

7. The method of claim 1, further comprising triggering via the first circuit, the second circuit to perform the classification of the input data stream, in response to a predefined time period elapsing without the state change being detected.

8. The method of claim 1, further comprising, triggering, via the first circuit, the second circuit to return to the dormant state and setting a subsequent classification for at least one subsequent input of the input data stream to be equal to a previously computed classification for a preceding input of the input data stream.

9. An apparatus, comprising:
an input device to receive an input data stream from one or more sensors;
a state change detection device to detect, while a second circuit is in a dormant state, if a state change has occurred between a first input of the input data stream and a second input of the input data stream, the second input being a next succeeding input to the first input of the input data stream; and
a control device to trigger the second circuit to perform a classification of the input data stream, in response to detecting the state change.

10. The apparatus of claim 9, in which the second circuit includes a feature extractor, and the control device, triggers the feature extractor to extract a set of features of at least the second input of the input data stream.

11. The apparatus of claim 9, in which the state change detection device computes a similarity score between the first input and the second input, the state change being detected based on the similarity score.

12. The apparatus of claim 11, in which the state change detection device compares the similarity score to a predefined threshold and detects the state change has occurred in response to the similarity score being below the predefined threshold.

13. The apparatus of claim 12, in which the control device triggers the second circuit to return to the dormant state, in response to a second similarity score computed for the second input and a third input exceeding the predefined threshold.

14. The apparatus of claim 11, in which the similarity score is computed based on a metric selected from a group consisting of a peak signal to noise ratio, a structural similarity, and a cosine similarity.

15. The apparatus of claim 9, in which the control device triggers the second circuit to perform the classification of the input data stream, in response to a predefined time period elapsing without the state change being detected.

16. The apparatus of claim 9, in which the state change detection device comprises a binary classifier.

17. An apparatus, comprising:
means for receiving, via a first circuit, an input data stream from one or more sensors;
means for detecting, via the first circuit, while a second circuit is in a dormant state, if a state change has occurred between a first input of the input data stream and a second input of the input data stream, the second input being a next succeeding input to the first input of the input data stream; and
means for triggering, via the first circuit, the second circuit to perform a classification of the input data stream, in response to detecting the state change.

18. The apparatus of claim 17, further comprising means for triggering, via the first circuit, the second circuit to extract a set of features of at least the second input of the input data stream.

19. The apparatus of claim 17, further comprising means for computing, via the first circuit, a similarity score between the first input and the second input, the state change being detected based on the similarity score.

20. The apparatus of claim 19, further comprising means for comparing, via the first circuit, the similarity score to a predefined threshold; and means detecting the state change has occurred in response to the similarity score being below the predefined threshold.

21. The apparatus of claim 20, in which the similarity score is based on a metric selected from a group consisting of a peak signal to noise ratio, a structural similarity, and a cosine similarity.

22. The apparatus of claim 17, further comprising means for triggering via the first circuit, the second circuit to perform the classification of the input data stream, in response to a predefined time period elapsing without a state change being detected.

23. The apparatus of claim 17, further comprising, means for triggering, via the first circuit, the second circuit to return to the dormant state.

24. A non-transitory computer readable medium having encoded thereon program code, the program code being executed by a processor and comprising:
program code to receive, via a first circuit, an input data stream from one or more sensors;
program code to detect, via the first circuit, while a second circuit is in a dormant state, if a state change has occurred between a first input of the input data stream and a second input of the input data stream, the second input being a next succeeding input to the first input of the input data stream; and
program code to trigger, via the first circuit, the second circuit to perform a classification of the input data stream, in response to detecting the state change.

25. The non-transitory computer readable medium of claim 24, further comprising program code to trigger, via the first circuit, the second circuit to extract a set of features of at least the second input of the input data stream.

26. The non-transitory computer readable medium of claim 24, further comprising program code to compute, via the first circuit, a similarity score between the first input and the second input, the state change being detected based on the similarity score.

27. The non-transitory computer readable medium of claim 26, further comprising program code to compare, via the first circuit, the similarity score to a predefined threshold; and detecting the state change has occurred in response to the similarity score being below the predefined threshold.

28. The non-transitory computer readable medium of claim 26, in which the similarity score is based on a metric selected from a group consisting of a peak signal to noise ratio, a structural similarity, and a cosine similarity.

29. The non-transitory computer readable medium of claim 24, further comprising program code to trigger, via the first circuit, the second circuit to perform the classification of the input data stream, in response to a predefined time period elapsing without a state change being detected.

30. The non-transitory computer readable medium of claim 24, further comprising program code to trigger, via the first circuit, the second circuit to return to the dormant state.
